(19) United States
(12) Patent Application Publication
(10) Pub. No.: US 2008/0199771 A1
(43) Pub. Date: Aug. 21, 2008

(54) BATTERY POSITIONING STRUCTURE OF AN ELECTRIC VEHICLE

(75) Inventor: Chien-Liang CHIU, Taipei (TW)

Correspondence Address: EGBERT LAW OFFICES, 412 MAIN STREET, 7TH FLOOR, HOUSTON, TX, 77002, US

(73) Assignee: WU'S TECH Co., Ltd., Taipei (TW)

(21) Appl. No.: 11/676,281

(22) Filed: Feb. 17, 2007

(51) Int. Cl. H01M 2/10

(52) U.S. Cl. 429/186

(57) ABSTRACT

The improved battery positioning structure of an electric vehicle includes a flexible pull handle, being mounted at one side of a battery and forming a handle portion and at least one snapping portion. The snapping portion can protrude from the hole at one side of the battery and is recessed if the handle portion is pulled upwards. A positioning groove is placed onto a side wall of the chamber and is used for positioning of the snapping portions. When the battery is removed, the handle portion of the flexible pull handle is pulled to enable the snapping portions to be disengaged from the positioning groove, thus releasing the battery. The batter can be quickly lifted via the handle portion. When the battery is returned to be positioned in the chamber, the handle portion is pressed to enable the snapping portions to be fixed securely into the positioning groove. Thus, the battery of the electric vehicle can be removed and positioned more simply, quickly and conveniently.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to an electric vehicle, and more particularly to an innovative battery positioning structure placed on an electric vehicle.

2. Description of Related Art Including Information Disclosed Under 37 CFR 1.97 and 37 CFR 1.98.

The power supply of an electric vehicle wholly relies on the battery, which is usually positioned at a preset location on the electric vehicle. Also, electrical re-charging is required due to the limited power storage of the battery.

The rechargeable battery of the conventional electric vehicle is formed so as to allow the electric vehicle to be placed nearby a socket and recharged by the charging lines, without removing the battery. However, this charging mode is limited to the environment of the user, which may or may not provide this access to a socket.

Therefore, a removable battery developed to serve many other purposes in many applications, but the removable battery in an electric vehicle developed for easier recharging of the battery in the electric vehicle. In such a case, the positioning of the removable battery on the electric vehicle plays a crucial role in the ability to remove or to reposition the battery quickly and conveniently.

The batteries of currently available electric vehicles are generally positioned by several loop fasteners, or placed in a container and then covered by plate. The loop fasteners have the disadvantage of poor positioning stability, quicker loss of adhesiveness, and lack of durability. The container and plate combination requires multiple steps. First, the cover must be removed. If the cover is provided with a positioning switch, then the switching action is also required in the process of removing and repositioning, making it impossible to remove the battery quickly.

Thus, to overcome the aforementioned problems of the prior art, it would be an advancement in the art to provide an improved structure that can significantly improve efficacy.

To this end, the inventor has provided the present invention of practicability after deliberate design and evaluation based on years of experience in the production, development and design of related products.

### BRIEF SUMMARY OF THE INVENTION

The improved battery positioning structure of the electric vehicle of the present invention has more advantages than the typical prior art structure. To remove the battery 10, the handle portion 31 of the flexible pull handle 30 is pulled to enable the two snapping portions 32 to be disengaged from the positioning groove 40 of two side walls 22 of the chamber 21, thus placing the battery 10 in a release state. The battery 10 can be quickly lifted via the handle portion 31. When the user is intended to position the battery 10 within the chamber 21, the handle portion 31 of the flexible pull handle 30 is pressed to enable two snapping portions 32 to be fixed securely into the positioning groove 40 of the chamber 21. Thus, the battery 10 of the electric vehicle is removed and positioned more simply, quickly and conveniently.

The improvements brought about by this invention include a discharge ditch 24, being arranged at a bottom of the chamber 21, such that the moisture infiltrated between the battery 10 and chamber 21 is removed or discharged more smoothly during cleaning of the chamber 21.

Also, male and female snappers 34, 17 are arranged at two sections of the handle portion 31 of the flexible pull handle 30 opposite to the internal groove 11 of the battery 10. Thus, the snapping portion 32 of the flexible pull handle 30 is snapped and fixed securely for positioning of the battery.

The present invention also includes convex and concave coupling portions 18, 27 set on the bottom of battery 10 opposite to the bottom 23 of the chamber 21. When the chamber 21 is assembled properly into the battery 10, the concave and convex coupling portions 27, 18 are mated perfectly against failure. These structures aim to ensure that positive pole strip 13 and negative pole strip 14 on the bottom of the battery 10 align with positive conductive strip 25 and negative conductive strip 26 on the bottom 23 of the chamber 21 for activation.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a perspective view of an electric vehicle with the battery positioning structure of the present invention.

FIG. 2 shows an isolated perspective view of the battery and battery positioning structure of the present invention, as separated from the electric vehicle chamber of the electric vehicle.

FIG. 3 shows perspective views of the bottom structure of the battery, as used by the present invention.

FIG. 4 shows a perspective view of the sequence of the flexible pull handle of the present invention in operation.

FIG. 5 shows cross-sectional views of the flexible pull handle of the present invention in operation.

FIG. 6 shows an elevation view of an electric wheel chair, having a battery mounted thereon by the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

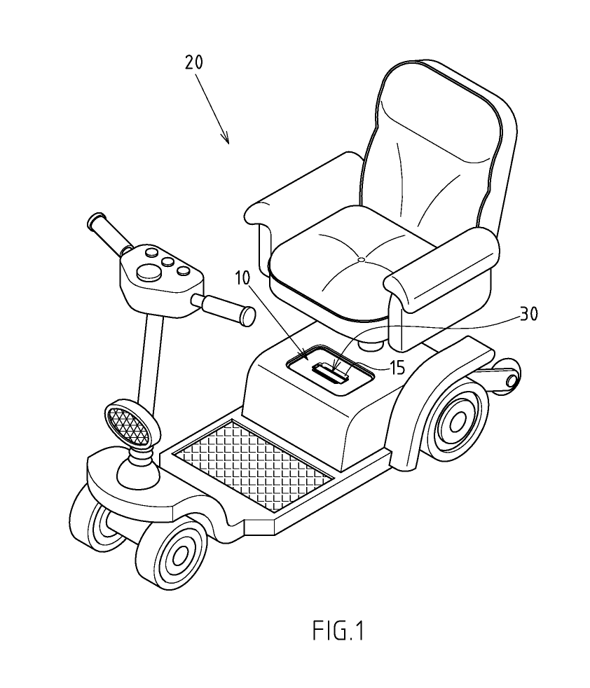

FIGS. 1, 2 and 3 depict the improved battery positioning structure of an electric vehicle of the present invention. The battery positioning structure is provided only for explanatory purposes. The scope of the patent is set by the patent claims.

The battery 10 is placed in a preset chamber 21 of the electric vehicle 20 and fixed by a positioning member.

The improved battery positioning member includes a flexible pull handle 30 made of plastic materials, which is placed on top of the battery 10. The flexible pull handle 30 includes a handle portion 31 at a central section thereof and two snapping portions 32 at both sides thereof. The two snapping portions 32 penetrate through the internal groove 11 of battery 10, and protrude from the holes 12 on both sides of the battery 10. When the handle portion 31 is pulled upward, two snapping portions 32 are recessed into the holes 12 of the battery 10.

Two positioning grooves 40 are placed onto two opposite side walls 22 of the chamber 21 of electric vehicle 20. These positioning grooves 21 are used for positioning of snapping portions 32 at both sides of the flexible pull handle 30.

A discharge ditch 24 is arranged at the bottom 23 of the chamber 21.

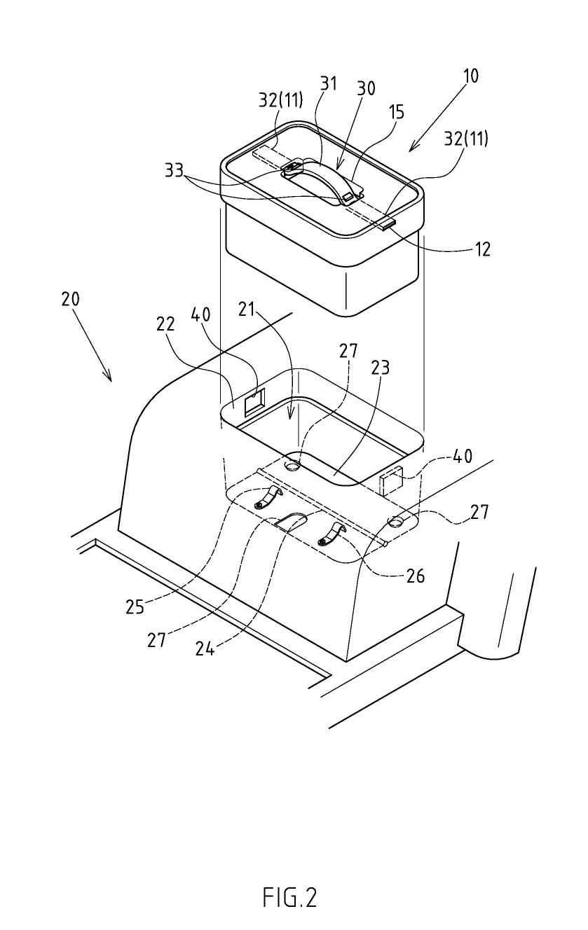

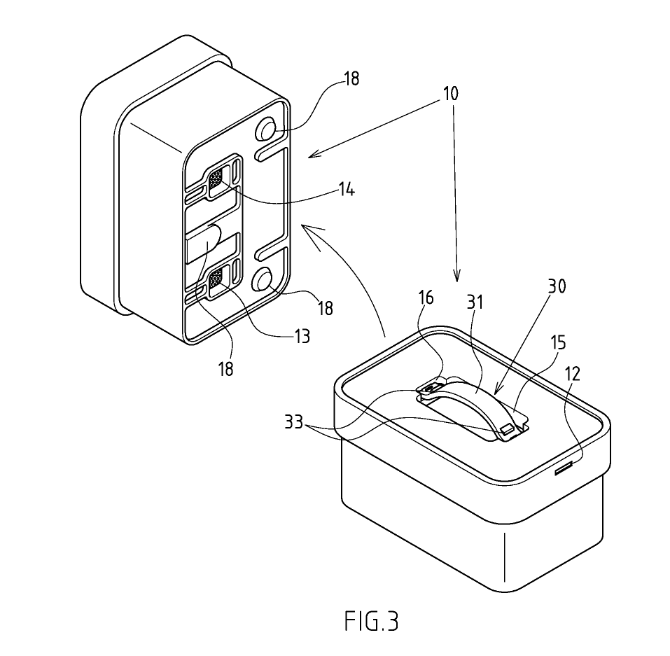

Referring to FIG. 3, positive pole strip 13 and negative pole strip 14 are arranged at intervals on the bottom of battery 10, such that positive conductive strip 25 and negative conductive strip 26 are separately placed on the bottom 23 of the chamber 21 (shown in FIG. 2). When the battery 10 is put into the chamber 21, the positive/negative pole strip 13, 14 contact electrically the positive/negative conductive strip 25, 26.

At the top of the battery 10, a recessed groove 15 is placed for insertion of the central handle portion 31 of the flexible pull handle 30.

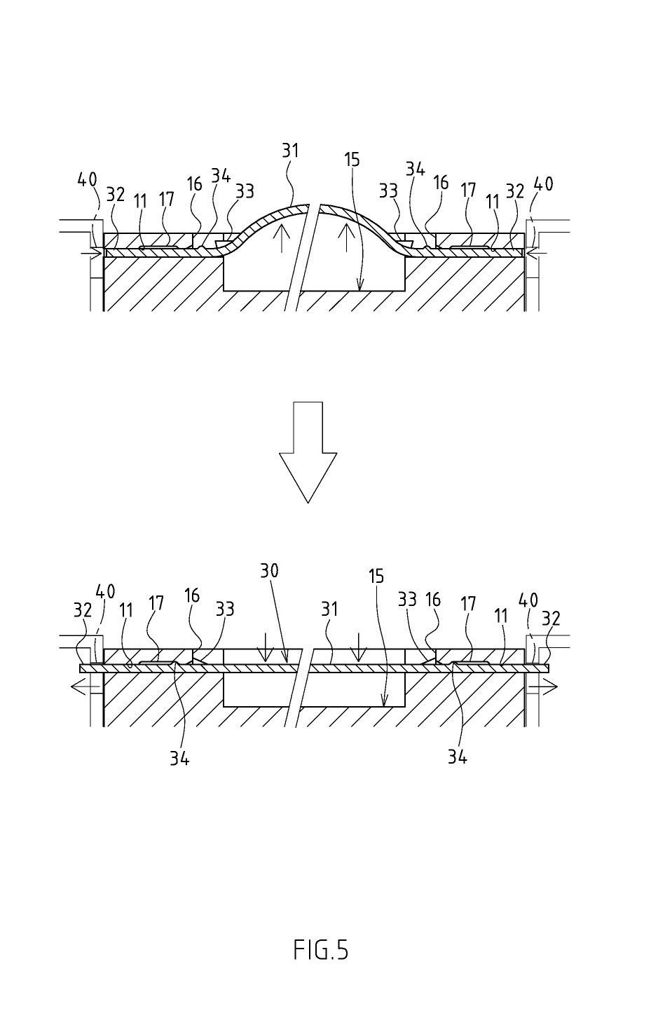

The handle portion 31 of the flexible pull handle 30 is provided with two protruding stoppers 33, which are trapped in the recessed groove 15 of the handle portion 31 (shown in FIG. 5), and stopped at two side walls 16 of the recessed groove 15.

Referring to FIG. 5, male and female snappers 34, 17 are arranged at two sections of the handle portion 31 of the flexible pull handle 30 opposite to the internal groove 11 of the battery 10, such that the snapping portion 32 of the flexible pull handle 30 is snapped and fixed securely.

A convex coupling portion 18 (shown in FIG. 3) and a concave coupling portion 27 (as shown in FIG. 2) are set on the bottom of battery 10 opposite to the bottom 23 of the chamber 21. When the chamber 21 is assembled properly onto the battery 10, the concave and convex coupling portions 27, 18 are mated perfectly against failure. These structures ensure that positive pole strip 13 and negative pole strip 14 on the bottom of the battery 10 align with positive conductive strip 25 and negative conductive strip 26 on the bottom 23 of the chamber 21 for activation.

Based upon the above-specified structures, the present invention is operated as follows:

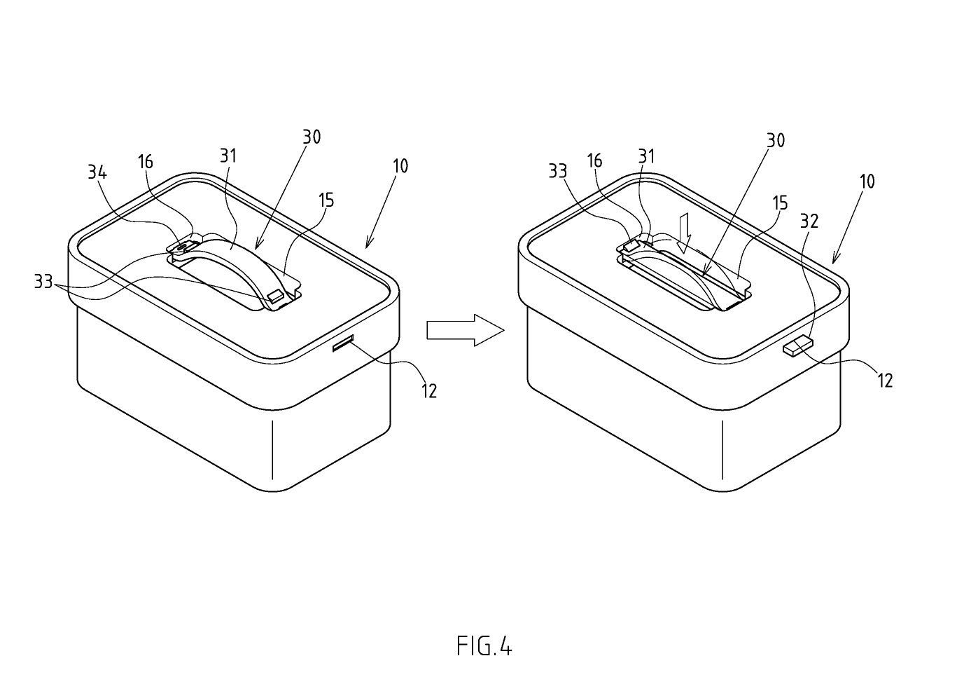

Referring to FIGS. 2, 4, and 5, when the battery 10 is removed, the handle portion 31 of the flexible pull handle 30 is pulled to enable two snapping portions 32 to be disengaged from the positioning groove 40 of two side walls 22 of the chamber 21, thus placing the battery 10 into a release state. In such a case, the battery 10 can be lifted, via the handle portion 31, to the charging location. The battery 10 can be removed quickly by simply pulling the handle portion 31 of the flexible pull handle 30.

Referring also to FIGS. 2, 4, and 5, when the battery 10 is placed into the chamber 21, the handle portion 31 of the flexible pull handle 30 is pressed to enable the two snapping portions 32 to be fixed securely into the positioning groove 40 of the chamber 21.

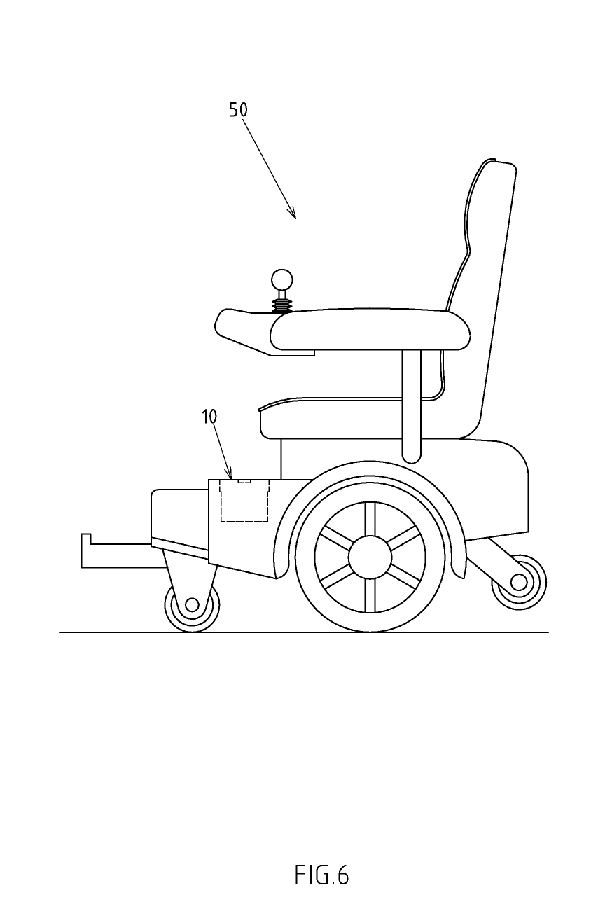

Furthermore, in addition to the electric vehicle disclosed in FIG. 1, the innovative battery positioning structure of the present invention can also be applied in an electric wheel chair 50 disclosed in FIG. 6, thus making it possible to remove and position the battery 10 more conveniently and quickly.

I claim:

1. A battery positioning structure of an electric vehicle, said electric vehicle having a battery and a preset chamber housing said battery, said battery positioning structure comprising:
a flexible pull handle, being mounted on one side of said battery and having a central handle portion and two snapping portions at both sides thereof, said two snapping portions penetrating through an internal groove of said battery and protruding from holes on both sides of said battery, said central handle portion being able to be pulled upwards as said two snapping portions are recessed into said holes of said battery, said preset chamber having a plurality of positioning grooves, said positioning grooves being placed on a side wall of said preset chamber, said positioning grooves engaging said two snapping portions at both sides of said flexible pull handle.

2. The battery positioning structure defined in claim 1, wherein said preset chamber has a discharge ditch arranged at a bottom of said preset chamber.

3. The battery positioning structure defined in claim 1, wherein said battery has positive and negative pole strips arranged at intervals on a bottom of said battery, said preset chamber having positive and negative conductive strips separately placed on a bottom of said chamber, said battery being placed in said preset chamber so that said positive and negative pole strips electrically contact said positive and negative conductive strips.

4. The battery positioning structure defined in claim 1, wherein said battery has a recessed groove placed on a top of said battery, corresponding to said central handle section of said flexible pull handle.

5. The battery positioning structure defined in claim 4, wherein said central handle portion of said flexible pull handle has two protruding stoppers, being trapped in said recessed groove of said central handle portion and stopped at two side walls of said recessed groove.

6. The battery positioning structure defined in claim 1, wherein said central handle portion has male and female snappers arranged at two sections of said central handle portion opposite to said internal groove of said battery, said two snapping portions being snapped and fixed securely.

7. The battery positioning structure defined in claim 1, wherein said battery has convex and concave coupling portions set on a bottom of said battery and opposite to a bottom of said preset chamber, said preset chamber being assembled with said battery, said concave and convex coupling portions being perfectly aligned and engaged with each other.
